(19) United States
(12) Patent Application Publication
(10) Pub. No.: US 2009/0255528 A1
(43) Pub. Date: Oct. 15, 2009

(54) Low pressure water-heating solar panel apparatus and method

(75) Inventors: Gary K. Weise, Placentia, CA (US); Richard J. Kesl, Plancentia, CA (US)

Correspondence Address: Terry L. Miller, 24832 Via San Fernando, Mission Viejo, CA, 92692, US

(73) Assignee: Thermocraft Industries, Inc.

(21) Appl. No.: 12/386,236

(22) Filed: Apr. 15, 2009

Related U.S. Application Data
(63) Continuation-in-part of application No. 10/979,444, filed on Nov. 1, 2004, now abandoned.

(51) Int. Cl. F24J 2/46; F24J 2/04; B23P 15/26

(52) U.S. Cl. 126/623; 126/634; 29/890.033

(57) ABSTRACT

An improved low-pressure, water-heating solar panel provides easier and safer initial installation because it is more resistant to damage by workmen during that installation. Further, after installation, the solar panel is more resistant to damage by high winds because it has a low profile and does not present a gap or space into which high winds can intrude to lift, flap, and damage the solar panel. Also, during freezing weather the improved solar panel is not damaged by freezing of retained water due to its novel internal construction which allows all water to completely drain from the solar panel and prevents any puddling of retained water. Methods of manufacturing the improved solar panel are disclosed.

### CROSS REFERENCE TO RELATED APPLICATION

This application is a Continuation-in-Part of U.S. patent application Ser. No. 10/979,444, filed 1 Nov. 2004, now U.S. patent Ser. No. ______, issued, and the disclosure of which is incorporated herein by reference to the extent necessary for a complete and enabling disclosure of the present invention.

### BACKGROUND OF THE INVENTION

The present invention relates generally to a low-pressure, water-heating solar panel of the type generally used to heat water for a swimming pool or spa, although the invention is not so limited. Some of these solar panels are generally referred to as being of “mat” construction or type, because they include a mat of plural relatively small, elongate parallel tubes or conduits, which may be connected to one another in side-by-side parallel array by a web of material, and which are terminated at each of their opposite ends in water flow communication with a respective manifold conduit. The pair of larger manifold conduits generally extend perpendicularly to the small tubes of the mat. Particularly, such low-pressure, water-heating solar panels of this type are used to circulate water from a pool or spa under relatively low pressure (perhaps provided by a pool pump, or by a solar heating pump—which may be line powered or even may be powered by solar electric panels) in heat absorbing relation with solar radiation (i.e., sun-exposed). For this purpose, such solar panels are generally installed adjacent to, or on the roof perhaps, of a residence or other building having an associated pool which it is desired to heat. By the use of such solar pool and spa heating, the use of natural gas and other fossil fuels for pool and spa heating is eliminated or greatly reduced. Also, the swimming season for the pool and/or spa is greatly extended in both the spring and the fall in areas where such a pool or spa may otherwise be usable (with comfortably warm water temperatures) only during a comparatively short mid-summer part of each year.

Conventional low-pressure solar panels of this type include the mat structure of plural relatively small parallel tubes or conduits, and respective opposite manifold tubes or conduits of a size considerably larger than the mat tubes. During manufacture of such mat type solar panels, a number of alternative manufacturing expedients may be utilized. One such manufacturing expedient is to extrude the tubes of the mat, along with an interconnecting web or diaphragm, as a long extrudate (i.e., an elongate article made by extrusion of molten plastic through a profiled die followed by cooling of the plastic) provided in rolls for installation. The manifold tubes are then provided with a parallel plurality of outwardly projecting hose barbs or nipples, to which the mat is connected after being cut to the desired length. That is, the plural small tubes of the mat are individually fitted over a respective hose nipple at the manifolds in order to connect the manifolds and mat. This fitting job is generally done by an installation technician, who also completes the remainder of the solar panel installation. This version of mat type solar panel is very labor intensive to install, although it has found some favor with the “do it yourself” home owners.

Another form of such a mat configuration of low-pressure water-heating solar panel takes the form of a mat of plural tubes which is either solvent welded, or sonically welded, or over-cast into flow communication with a pair of manifold tubes.

In each of the conventional mat type of low-pressure, water-heating solar panels discussed above, the mat of plural tubes intersects the manifold tubes in alignment with the longitudinal axis of the manifold tubes. As will be seen, this construction has a serious disadvantage, especially in parts of the country where freezing temperatures are experienced during winter.

Consideration of how such mat type of low-pressure, water-heating solar panels are installed and used will reveal that such panels are generally held on a frame, perhaps mounted to a roof, and have the manifold tubes disposed generally horizontally, with the plural tubes of the mat extending generally vertically. In this orientation, low-pressure water from a pool or spa is pumped to the panel along one of the manifold tubes, flows along the plural relatively small tubes of the mat in heat absorbing relation with sunlight, and is collected at the other manifold tube. During warm weather conditions, this scheme of operation works well. However, in areas which experience freezing temperatures, the solar panel must be drained in order to prevent freezing water within the panel from destroying the panel structure. To this end, many solar panel installations include a vacuum breaker valve which is temperature response so as to open and allow draining of water from within the solar panel in the even the ambient temperature drops close to freezing, to about 34° F., for example. In this way, it is sought to safeguard the solar panel from damage by water freezing within the panel. As will be seen, these efforts are ineffective with conventional solar panel designs.

A common problem resulting from the imperfect design of conventional solar panels of the type discussed above is that not all water is able to drain from the panel. That is, a puddle of water remains in the panel after draining, and may freeze to damage the solar panel. Such is the case because water may be trapped in one of both of the manifold tubes, and be unable to drain from the panel. Turning now to consideration of the appended drawing Figure indicated as “prior art,” it is seen that a conventional mat type of solar panel 10 is attached in an angled orientation to a support surface, which may be provided by a support rack or roof, generally indicated with the numeral 12. This angulated orientation of the conventional solar panel both improves the presentation of the panel area to the sun, and is supposed to effect draining of the solar panel when it is desired to protect the panel from freezing conditions. Consideration of the construction of the solar panel 10 will show that it includes an elongate “mat” section 14 consisting of plural side-by-side relatively small solar collector tubes 16 (only the closest one to the view of which is visible in the “prior art” Figure). The tubes 16 are generally formed as part of an elongate plastic or polymer extrudate, including a relatively thin interconnecting web, indicated with the numeral 18. At the upper and lower ends of the mat 14, the plural tubes 16 are each connected in flow communication with a respective manifold tube 20, 22 of a size considerably larger than the small tubes of the mat 14. The small tubes 16 and the manifold tubes 20, 22 intersect or interconnect along lines intersecting the centerlines of the small tubes 16 and of the larger manifold tubes 20, 22.

Consequently, when the solar panel 10 is supported on a flat (and perhaps angled as shown) surface, then the mat 14 of the solar panel 10 spans between the manifold tubes 20, 22 above the surface 12, defining a gap, indicated with the numeral 24. Actually, because the mat 14 is made of a somewhat flexible plastic material, this mat sags between the tubes 20 and 22, so that over most of its length it rests upon the surface 12, except adjacent to the manifold tubes 20 and 22. Consequently, as is seen in the upper part of the “prior art” Figure, when the solar panel 10 is drained, a puddle of water still remains in the upper manifold tube 22. This puddle of water may be sufficient that water not drained from the solar panel intrudes into fissures and cracks of the solar panel. Perhaps these fissures and cracks would not otherwise cause a problem, but over time as these fissures and cracks of the solar panel are widened and weakened by repeated cycles of water freezing and expanding in them, they can lead to leaks of the solar panel. In fact, such leaks of this type of solar panel in areas experiencing freezing temperatures are a leading cause of warranty claims, customer dissatisfaction, and complaints against this type of solar panel.

As can be seen, there is a need for an improved low-pressure, water-heating solar panel that will drain completely so as not to retain water that may freeze within the panel.

Also, there is a need for an improved low-pressure, water-heating solar panel that may more easily be installed on a rack or on a roof, for example, in order to better support the solar panel and to protect it from severe weather conditions, such as high winds. As can be seen from the “prior art” Figure, conventional solar panels of this type do not fit closely to the rack or roof surface on which they are mounted, and present an opportunity for high winds to lift the solar panel. Once such a conventional solar panel is lifted and strong winds get under the solar panel, the chances of the panel being damaged or destroyed are very great.

### SUMMARY OF THE INVENTION

In view of the deficiencies of the conventional technology, an objective for this invention is to reduce or eliminate one or more of these deficiencies.

Accordingly, as realized in one particularly preferred exemplary embodiment, the present invention provides

The low-pressure, water-heating solar panel according to the present invention includes a mat of relatively small tubes communicating at each opposite end with a respective one of a pair of larger manifold tubes. The mat of relatively smaller tubes joins with the larger manifold tubes along a line that is offset from the centerline of the manifold tubes, and which is preferably tangential along an inside wall or passage wall of the manifold tubes. By this expedient, the solar panel provides no recess or cavity within which water may puddle and not be drained from the solar panel.

Also, the present inventive solar panel installs at a lower height (or essentially flush) on a roof surface or mounting rack, so that the panel is both protected against damage during installation, and is more resistant to lifting off the rack or roof by high winds.

An advantage of the present invention is the resistance of the inventive solar panel to being broken or being damaged inadvertently during installation or during other work on a mounting rack or roof having the solar panel installed thereon.

Further, another significant advantage derives from the low-profile nature of the present inventive solar panel, in that the panel “hugs” the roof or rack to which it is mounted, and presents to ambient winds a much less accessible surface under which the wind may catch to lift the solar panel off is rack or roof mounting surface.

These and other aspects, objects, features and advantages of the present invention will become clear from a reading of the following detailed description of exemplary preferred embodiments of the invention when considered in conjunction with the accompanying drawings.

### BRIEF DESCRIPTION OF THE DRAWING FIGURES

FIG. 1 is an perspective diagrammatic view of an inventive solar panel embodying this present invention installed on a roof of a residence and in association with a residential swimming pool;

FIG. 2 provides a fragmentary plan view of the solar panel seen in FIG. 1;

FIG. 2A is a fragmentary cross sectional view of a mat portion of the solar panel seen in FIGS. 1 and 2;

FIG. 3 is a fragmentary side elevation view of the solar panel seen in FIGS. 1 and 2, and contrasts the construction of the present inventive solar panel with the conventional “prior art” solar panel;

FIG. 4 provides a fragmentary, exploded, side elevation view, partially in cross section, taken generally at the plane of line 4-4 on FIG. 2, and looking in the direction of the arrows;

FIG. 5 provides a fragmentary, exploded, side elevation view, partially in cross section, of an alternative embodiment of solar panel embodying this invention, and may be considered to be taken generally at the plane of line 4-4 on FIG. 2, and looking in the direction of the arrows;

FIG. 5A is a fragmentary view of the solar panel seen in FIG. 5;

FIG. 6 provides a fragmentary, exploded, side elevation view, partially in cross section, of another alternative embodiment of solar panel embodying this invention, and also may be considered to be taken generally at the plane of line 4-4 on FIG. 2, and looking in the direction of the arrows;

FIG. 6A is a fragmentary side elevation view of a portion of the solar panel seen in FIG. 6, and is taken at line 6A-6A of FIG. 6;

FIG. 7 provides a fragmentary perspective view of another portion of the solar panel seen in FIG. 6; and

FIG. 8 is a diagrammatic view in side elevation view of a bridge member which may be used to secure a solar panel according to this invention to a roof or support rack;

FIG. 9 is a fragmentary elevation view in cross section taken at line 9-9 of FIG. 8;

FIG. 10 provides a fragmentary view is elevation and partially in cross section of an alternative embodiment of a mat component of a solar panel according to this invention;

FIG. 11 is a diagrammatic view in side elevation, and partially in cross section, of yet another alternative embodiment of solar panel according to this invention;

FIG. 12 is also a diagrammatic view in side elevation, and partially in cross section, of still another alternative embodiment of solar panel according to this invention; and

FIG. 13, is designated “prior art” and illustrates in fragmentary side elevation view, partially in cross section, of a conventional low-pressure, water-heating solar panel.

### DETAILED DESCRIPTION OF PREFERRED EXEMPLARY EMBODIMENTS OF THE INVENTION

The following detailed description provides a disclosure of the best currently contemplated modes of carrying out the invention. The description is not to be taken as a limitation on the invention, but is provided merely for the purpose of illustrating exemplary embodiments of the invention which are particularly preferred, and by so doing, to bring forth the general principles of the invention. The spirit and scope of the invention is defined by the appended claims.

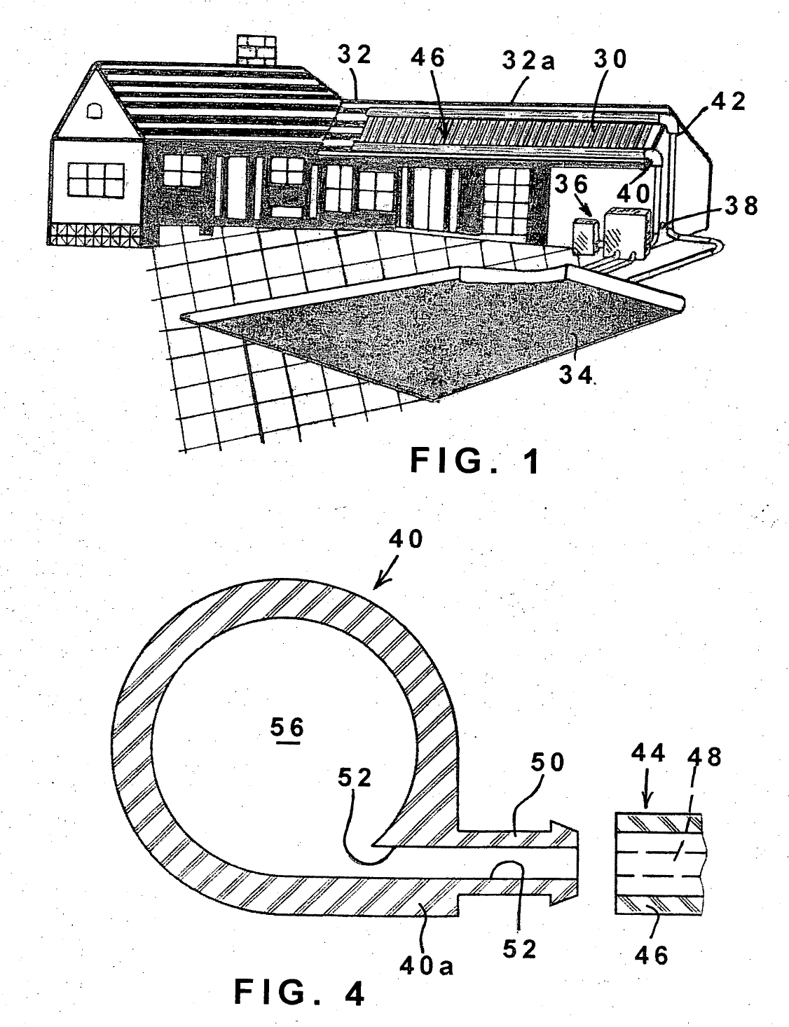

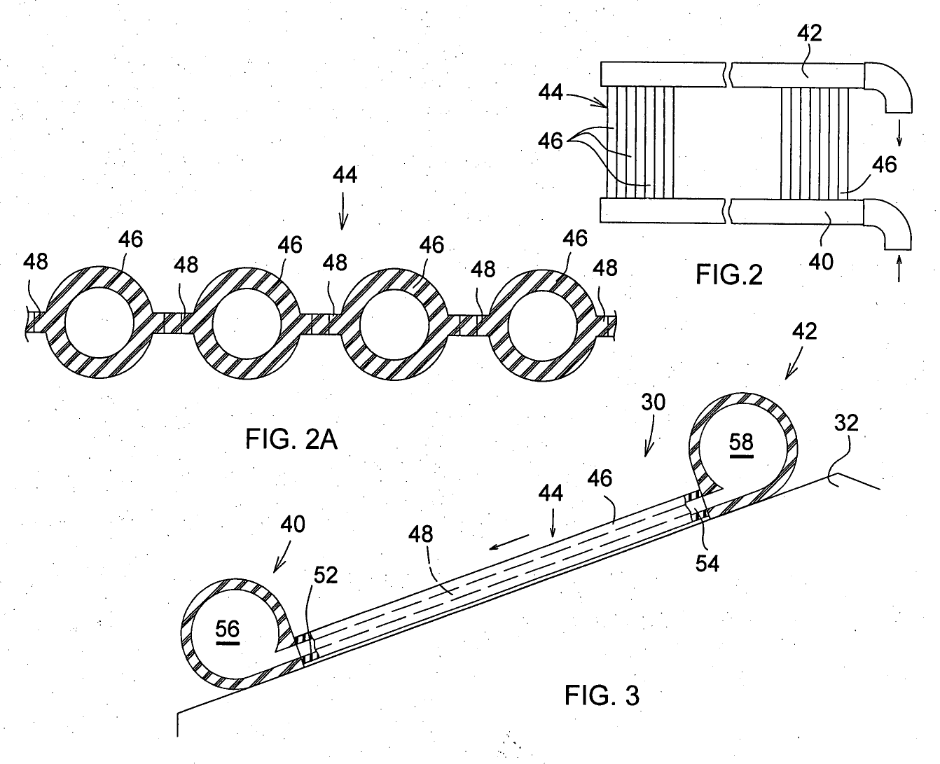

Viewing FIG. 1, an inventive solar panel 30 is installed on a support surface 32a, which may be provided by a rack or by the sloping, sun-exposed roof of a residential building or house 32. The solar panel 30 is associated in water-flow relation with the swimming pool 34 of this house. The swimming pool includes a filter-pump unit 36, which pumps water from the pool, filters this water, and returns the water either directly to the pool, or returns the water to the pool via the solar panel 30, dependent upon the position of a selector valve 38. For this purpose, the solar panel includes a pair of spaced apart generally horizontally extending manifolds 40, 42, (viewing also FIGS. 2, 2A, and 3) which are of tubular construction. As is illustrated in FIG. 2, the lower one 40 of these manifold tubes receives relatively cool water from the swimming pool, and the water flows upwardly toward the upper manifold tube 42 via a mat 44 of plural side-by-side relatively small tubes, each indicated with the numeral 46. As is best seen in FIG. 2A, the mat 44 includes a plurality of small solar collector tubes 46 formed as a plastic extrudate (i.e., an elongate article made by extrusion of molten plastic through a profiled die followed by cooling of the plastic) including a comparatively thin interconnecting web 48. The collector tubes 46 are exposed to and are heated by the sun, and they thus heat water flowing inside of these tubes. As is well understood in the pertinent arts, the thin web 48 unites the tubes 46, but also allows the tubes 46 to be separated (if needed) over a portion of their length in order to, for example, pass around an obstruction on the roof 32a such as a roof vent or stand pipe which penetrates the roof 32a. This feature of the extruded plastic mat type of low-pressure solar panels is well understood in the pertinent arts.

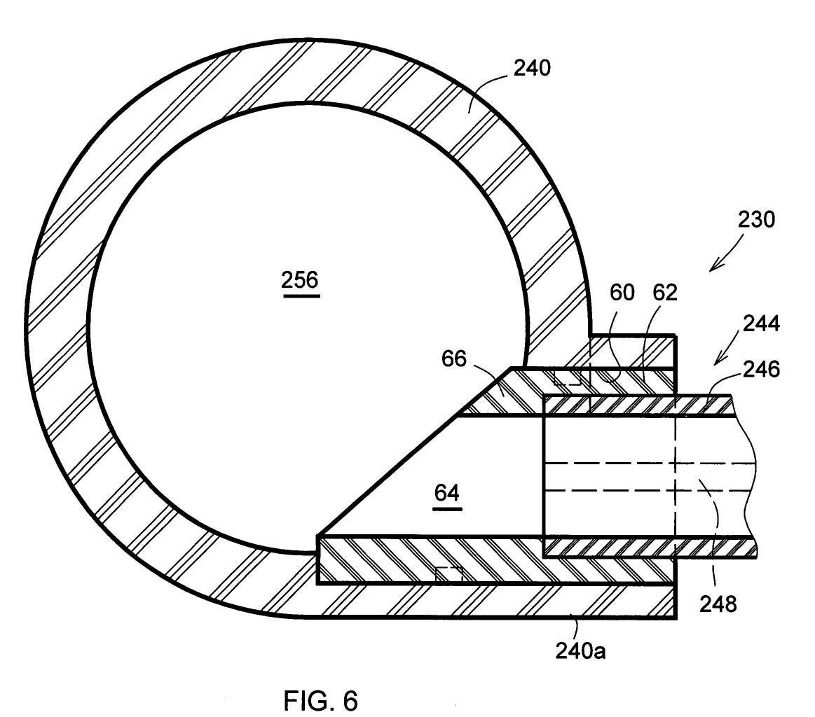

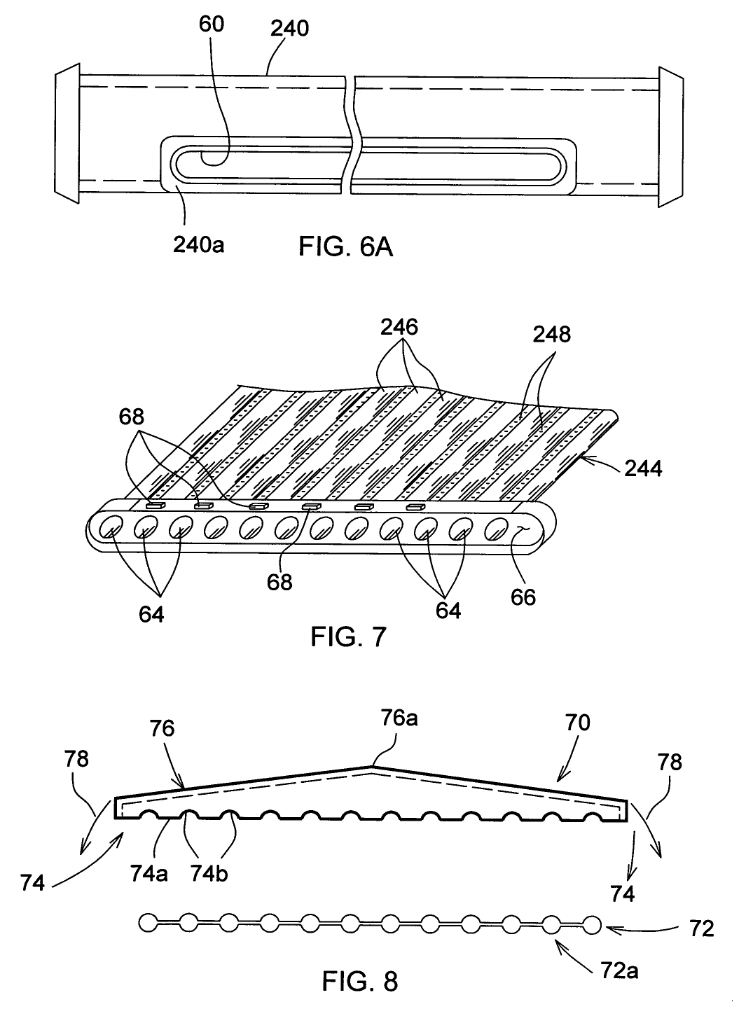

Viewing FIGS. 3 and 4, it is important to note that the manifold tubes 40, 42 outwardly are preferably not fully round, and include an outwardly extending elongate boss 40a, 42a along a central portion of the length of these manifold tubes (see FIG. 6A for an illustration of such a boss in front elevation view). The bosses 40a, 42a are disposed toward one another, and each one includes along its length an elongate array or row of outwardly projecting hose barbs or nipples (indicated with the numeral 50 on each manifold tube), each projecting toward the other manifold tube. Inwardly (and outwardly), these hose barbs 50 are aligned with one another in a row, as mentioned above, and each defines a respective through passage 52, 54 opening inwardly to the internal passage 56, 58, of the manifold tubes 40, 42. By this point in the description, it will be apparent that the manifold tubes 40 and 42 are identical pieces, with each one turned to face the other. Consequently, these pieces 40 and 42 are referred to hereinafter collectively and individually with the composite numeral “40/42.” Further, a similar annotation is used in the remainder of this specification for the same purpose. As is to be further noted by viewing FIGS. 3 and 4, the internal passages 52, 54 of the plural hose barbs 50 open to the internal bores or passages 56/58 of the respective manifold tube 40/42 substantially tangentially to the internal passages 56/58.

Outwardly, the plural hose barbs 50 each receive thereon an end portion of a respective one of the tubes 46 of the mat 44, so (as is best illustrated in FIG. 3) the mat 44 is disposed substantially adjacent to the roof 32a along its entire length. In other words, and in contrast to the conventional solar panel construction seen in prior art FIG. 7, the mat portion of the present inventive solar panel does not define a gap with the supporting roof, not even at or adjacent to the manifolds of the solar panel. Additionally, the mat portion of the present solar panel does not have to sag in order to come into supporting relationship with a roof or supporting rack over a portion of its length as is the case with the prior art conventional solar panels. This feature of the present inventive solar panel means that the panel is much less at risk of damage during installation, because there is no sagging and partially unsupported portion of the mat, upon which a workman may inadvertently step to damage the solar panel. The absence of a gap below the mat of the present inventive solar panel (especially adjacent to the manifold tubes) also means that there is no space beneath the solar panel into which high winds may intrude to lift and damage the present inventive solar panel.

Now, and very importantly, comparing and contrasting the prior art illustration of FIG. 8, with the illustration in FIG. 3 of the present inventive solar panel, it is seen that the present inventive solar panel cannot harbor a trapped puddle of water which is not drained from the solar panel, as is seen in FIG. 3. This is the case regardless of the degree of slope upon which the present inventive solar panel is installed, and results from the tangential entry of the passages 52/54 to the manifold passages 56/58. And further, because the upper and lower manifold tubes of the present inventive solar panel are identical, it makes no difference which one is installed in the upper position along a slope. That is, both manifolds 40 and 42 drain equally well and completely, with no residual puddle of water trapped in them. So, regardless of orientation of the solar panel 30 at installation, the present inventive solar panel cannot retain un-drained water, and as a result, freezing weather is far less likely to damage the present inventive solar panel.

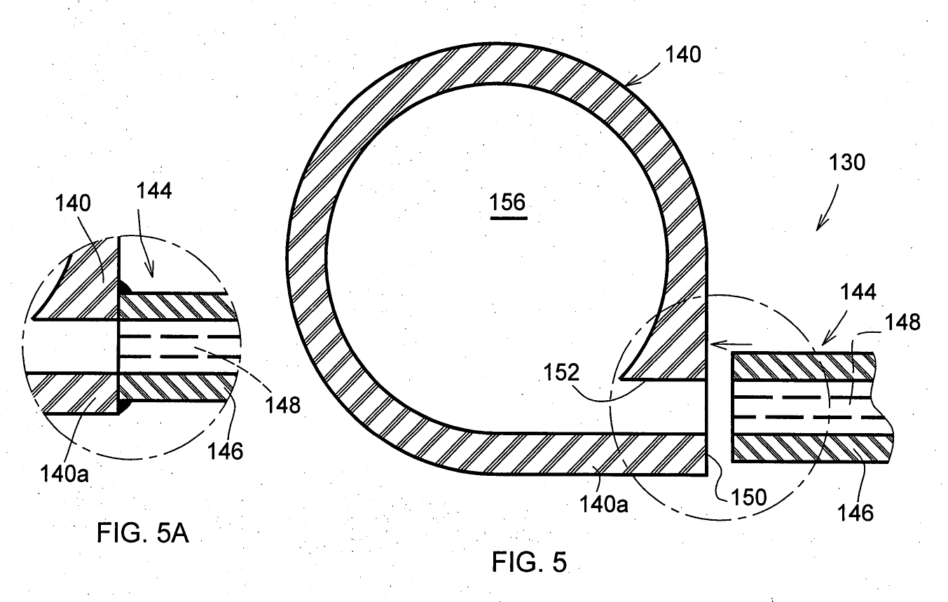

Turning now to FIG. 5, an alternative embodiment of the present inventive solar panel is illustrated. Because the solar panel of FIG. 5 shares many features with the first embodiment illustrated by reference to FIGS. 1-4, features which are the same, or which are analogous in structure or function to those depicted and described above are indicated on FIG. 5 with the same numeral used above, but increased by one-hundred (100). As is seen in FIG. 5, an inventive solar panel 130 includes a pair of spaced apart manifolds 140, 142 (only one of which is seen in FIG. 5—the other end of the solar panel being a mirror image) which are of tubular construction. The manifold tubes are in flow communication with a mat 144 of plural relatively small tubes 146 interconnected by a relatively thin web 148. Again, these manifold tubes 140, 142 outwardly are preferably not fully round, and each includes an outwardly extending elongate boss 140a, 142a (again, only one of which is seen in FIG. 5) along a central portion of the length of these manifold tubes. The bosses 140a, 142a are disposed toward one another, and outwardly each one defines a bluff outer surface (indicated with the numeral 150). The manifold tubes 140a, 142a each define a plurality of through passages 152, 152 (only the passages 152 of the manifold tube 140a being seen in FIG. 5) each opening inwardly to the internal passage 156, 158 (only passage 156 being seen in FIG. 5) of the manifold tubes 140, 142. Again, by this point in the description, it will be apparent that the manifold tubes 140 and 142 are identical pieces, with each one turned to face the other at the bosses 140a and 142a, and bluff surfaces 150. Accordingly, these like features are again referred to used the composite reference numerals, such as 140/142. As is to be further noted by viewing FIGS. 5 the internal passages 156/158 align with and are disposed in water-flow communication individually with respective opposite ends of a passage 146 of the mat 144. Viewing FIG. 5, it is seen that in order to accomplish attachment of the mat 144 to the manifold tubes 140/142 (indicated by the arrow on FIG. 5), expedients such as sonic welding, friction welding, or even adhesive attachment may be employed. However, sonic welding is the preferred method of attaching the mat 144 to the manifold tubes 140/142. Sonic welding of the mat 144 of tubes 146 results in a joint as is illustrated in FIG. 5A.

Again, it is seen that with this second embodiment of the present inventive solar panel, because of the tangential arrangement of the collector tubes 146 to the manifold tubes 140/142 the solar panel cannot harbor a trapped puddle of water which is not drained from the solar panel. This is the case because of the tangential entry of the passages 152/154 to the manifold passages 156/158.

Turning to FIG. 6, a third alternative embodiment of the present inventive solar panel is illustrated. Because the solar panel of FIG. 6 also shares many features with the first embodiment illustrated by reference to FIGS. 1-4, and with the second embodiment illustrated in FIG. 5, features which are the same, or which are analogous in structure or function, to those indicated in an earlier embodiment are referenced on FIG. 6 with the same numeral used above, but increased by one-hundred (200). Viewing now FIG. 6, an inventive solar panel 230 includes a pair of spaced apart manifolds 240, 242 (only one of which is seen in FIG. 6). The manifolds 240, 242 are of tubular construction. The manifold tubes are in flow communication with a mat 244 of plural relatively small tubes 246 interconnected by a relatively thin web 248. Again, these manifold tubes 240, 242 outwardly are preferably not fully round, and each includes an outwardly extending elongate boss 240a, 242a (again, only one of which is seen in FIG. 6) extending along a central portion of the length of these manifold tubes. Again, by this point in the description, it will be apparent that the manifold tubes 240 and 242 are identical pieces, with each one turned to face the other. The bosses 240a/242a are disposed toward one another, and each one sealingly receives a respective end portion of the mat 244, while providing flow communication between the plural tubes 246 and the respective manifold tube 240/242.

Considering FIGS. 6, 6A, and 7 in conjunction with one another, it is seen that the manifold tubes 240/242 define an elongate socket indicated with the reference numeral 60. This socket is disposed in a generally tangential orientation with respect to an inner wall of the passages 256/258 of the manifold tubes 240/242. Sealingly received into the sockets 60 of the respective manifold tubes is a respective “mold-over” plug member, indicated with the numeral 62. This plug member 62 sealingly joins with the plurality of tubes 246 of the mat 244, and defines an opening passage 64. The plug member 62 is preferably manufactured by injection molding this plug member directly onto an end portion of a section of mat material, with the injection molding process essentially making the plug member 62 integral with the mat.

On the other hand, expedients for securing the plug member 62 into the socket 60 include the use of adhesive or solvent welding. Alternatively, the plug member 62 may be sonically welded into the socket 60. However, the most preferred alternative is to over mold (i.e., injection mold) the manifold 240/242 directly upon the plug member 62. By this manufacturing method, the plug member 60 and manifold 240/242 also become essentially integral with one another. In order to allow such an over molding manufacturing operation to be performed, it is important to note that the plug member 60 defines an elongate angulated termination surface 66 (best seen in FIGS. 6 and 7) upon which the opening passages 64 open to the interior of the manifold tube 240/242. As is seen best in FIG. 6, the termination surface 66 essentially defines a cord line of the round passage 256/258. This feature of the plug member and its relation at surface 66 to the core which will form the passage 256/258 of the manifold 240/242 during the over-molding injection molding operation means that the injection molding core can be removed from the passage 240/242. Also, as is seen in FIG. 7, the outer surfaces of the plug member 60 may be provided with features for inter-securing the plug member 60 into the manifold tube 240/242. These securing features may include, for example, plural projecting lugs, or plural recesses, or ribs, or other features (generally indicated on FIG. 7 with the numeral 68) effecting a mechanical and sealing interlocking of the plug member into the manifold tube 240/242.

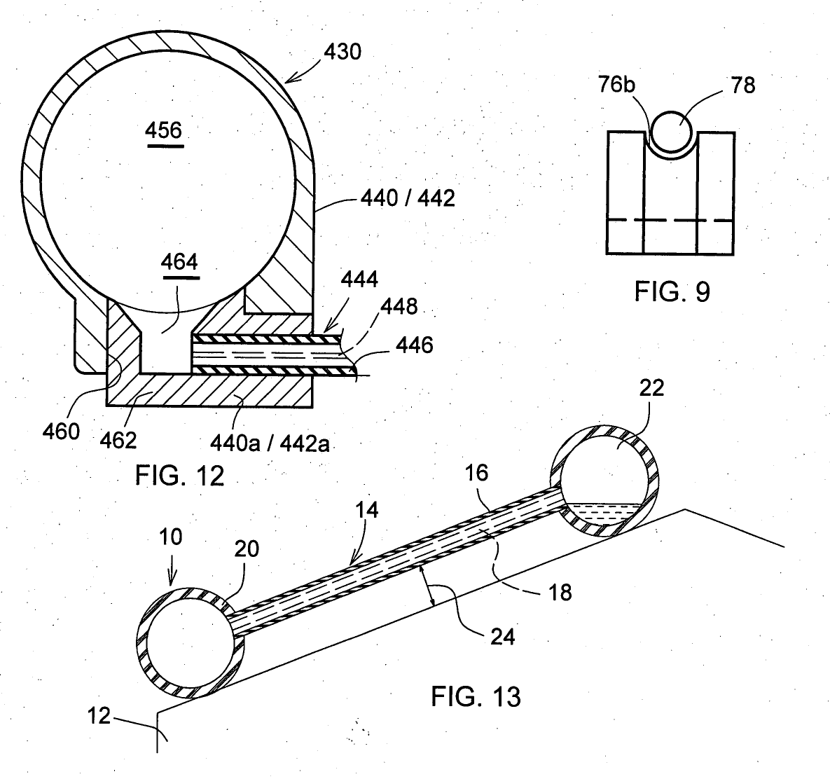

Considering now FIGS. 8 and 9 in conjunction with one another, a bridge member (or securing member) 70 is illustrated. The member 70 preferably is made of injection molded plastic, although the invention is not so limited. It will be noted that the member 70 spans across a solar panel 72, which is seen in cross sectional elevation view. As will be familiar to the reader, the solar panel 72 includes tube portions 72a interconnected by web portions 72b. Thus, it is noted that the bridge member 70 defines a crenellated lower surface 74 having plural aligned planar flat portions 74a engageable onto the web portions of the solar panel 72, interdigitating with plural semi-circular recesses 74b engageable onto the tube portions of the solar panel 72. Further, the bridge member 70 includes an upper surface 76 which is “humped” or peaked at 76a, and which defines an elongate groove 76b extending from side to side of the member 70. This groove 76b receives a flexible tension member, which may take the form of a cord or wire member 78; and the wire or cord 78 passes downwardly from the ends of the member 70 (as is seen in FIG. 8) to be secured to a roof or support rack holding the solar panel 72. Accordingly, it is seen that the member 70 inter-engages with a solar panel 72 according to this invention and applies a distributed securing force across the width of the solar panel by virtue of the tension member 78 bearing down across the member 70 and passing over the peak of this member at 76a.

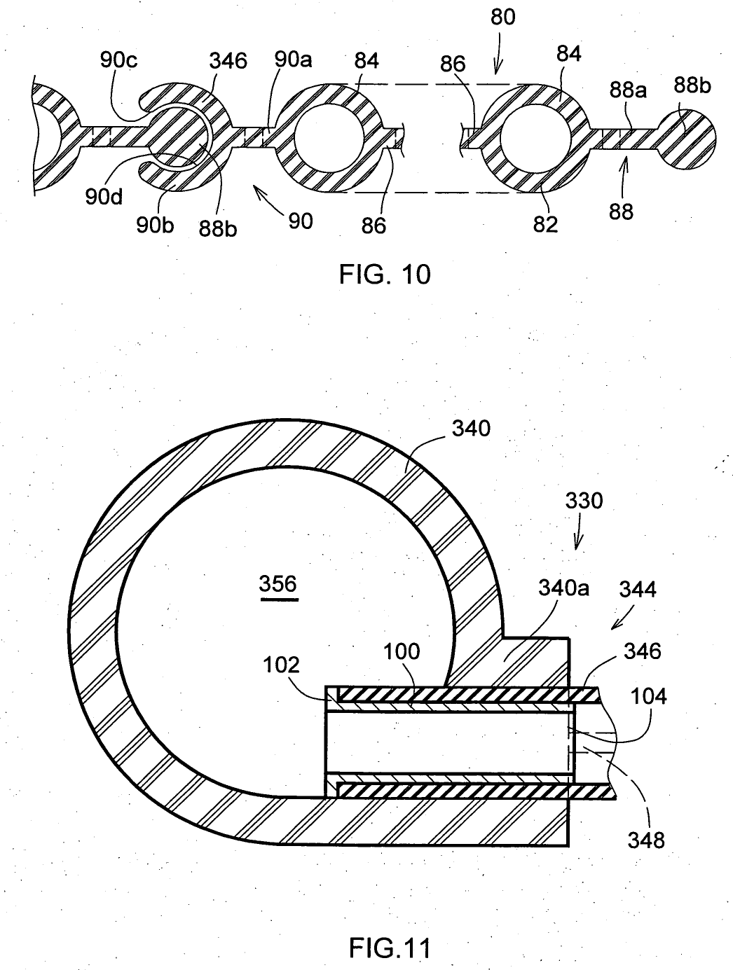

FIG. 10 illustrates in cross sectional (or end elevation) view a mat type of solar panel member according to this invention. While conventional mat type of solar panels have included plural side-by-side extrudate members, each including plural tubes interconnected by web portions, these conventional solar panels have had a disadvantage because of manufacturing difficulties. In order to solve or ameliorate one of these manufacturing difficulties, attention is directed to the improved solar panel mat seen in FIG. 10. This solar panel mat 80 includes an elongate extrudate body 82 defining plural solar collector tubes 84 for internally flowing water and for externally absorbing solar energy which is transferred to the flowing water. The plural tubes 84 are interconnected integrally with one another by web portions 86. Further, the mat 80 includes elongate inter-engageable opposite edge portions, indicated with the numerals 88 and 90. Edge portion 88 includes a web portion 88a extending from the outermost solar collector tube 84 and terminating in an elongate bead portion 88b. Conversely, the edge portion 90 includes an elongate web portion 90a also extending from the outermost solar collector tube 84 (i.e., on the side edge of mat 80 opposite to the bead portion 88b) and terminating in an elongate C-shaped channel portion 90b. The channel portion 90b outwardly is preferably about the same dimension at one of the solar collector tubes 84, and defines a channel opening 90c just slightly smaller than the bead portion 88b. The channel opening 90c leads to a channel 90d which is of sufficient size to receive the bead portion 88b. Consequently, when two elongate sections of the mat 80 are placed adjacent to one another, with the bead portion 88b confronting the channel portion 90b of the other, these sections of mat 80 can be interconnected with one another by “snapping” the bead of one section into the channel of the next adjacent section. In this way, mats for solar panels may be assembled in any desired width at a multiple of the width of the individual extrudate pieces manufactured to make up such mats. Subsequent manufacturing operations are thus easier because the mats so assembled can be handled as a single item or unit, rather than as a plurality of individual parts.

Turning now to FIG. 11, a portion of a solar panel according to this invention is illustrated in side elevation cross sectional view. The solar panel of FIG. 11 also shares many features with the first and second embodiments illustrated by reference to FIGS. 1-4, and by reference to FIG. 5, respectively. So, features which are the same, or which are analogous in structure or function, to those indicated in an earlier embodiment are referenced on FIG. 11 with the same numeral used above, but increased by one-hundred (100) over the last reference, or by three-hundred (300) over FIGS. 1-4. Considering to FIG. 11, an additional alternative embodiment of the present inventive solar panel is illustrated. Again because the solar panel of FIG. 11 shares many features with the embodiments illustrated and described earlier, features which are the same, or which are analogous in structure or function, to those indicated in an earlier embodiment are referenced on FIG. 11 with the same numeral used above, but increased by three-hundred (300) over FIGS. 1-4.

Viewing now FIG. 11, an inventive solar panel 330 includes a pair of spaced apart manifolds 340, 342 (only one of which is seen in FIG. 11). The manifolds 340, 342 are of tubular construction. The manifold tubes are in flow communication with a mat 344 of plural relatively small tubes 346 interconnected by a relatively thin web 348. Again, these manifold tubes 340, 342 outwardly are preferably not fully round, and each includes an outwardly extending elongate boss 340a, 342a (again, only one of which is seen in FIG. 11) extending along a central portion of the length of these manifold tubes. Again, by this point in the description, it will be apparent that the manifold tubes 340 and 342 are identical pieces, with each one turned to face the other. The bosses 340a/342a are disposed toward one another, and each one sealingly receives a respective end portion of the mat 344, while providing flow communication between the plural tubes 346 and the respective manifold tube 340/342.

In order to allow the manifold tubes 340/342 to be directly over-molded onto the mat 344 in a single injection molding operation, each of the tubes 346 of the mat 344 receives at an end portion thereof a flanged metal support member or eyelet 100. This eyelet is sized to snuggly slide into the end portion of the tubes 346 and to be there retained during the injection molding process producing the manifold tubes 340/342. Thus it is seen that these eyelets 100 includes a flange portion 102 which seals off against a core member of the injection molding die (not seen in the drawing Figures) during the injection process. The eyelets extends within each tube 346 from the flange 102 to a termination edge 104 which is coextensive with or beyond the face of the boss 342a, In this way, the tubes 346 are supported by the eyelets along their entire length which is exposed to injection molding pressures during the formation of the manifold tube 340.

FIG. 12 illustrates a portion of a solar panel 430 similar to the portion illustrated in FIG. 11. This portion of the solar panel is illustrated in side elevation cross sectional view. The solar panel of FIG. 12 similarly shares many features with the earlier-disclosed embodiments. Accordingly, features of FIG. 12 which are the same, or which are analogous in structure or function, to those indicated in an earlier embodiment are referenced on FIG. 12 with the same numeral used above, but increased by one-hundred (100) over the last reference, or by three-hundred (400) over FIGS. 1-4. Turning now to FIG. 12, a solar panel 430 includes a pair of spaced apart manifolds 440/442 (only one of which is seen in FIG. 12). The manifolds 440, 442 are of tubular construction. The manifold tubes are in flow communication with a mat 444 of plural relatively small tubes 446 interconnected by a relatively thin web 448. Once again, these manifold tubes 440/442 outwardly are preferably not fully round, and each includes a depending elongate boss 440a/442a (again, only one of which is seen in FIG. 12). The bosses preferably extend along a central portion of the length of these manifold tubes. As before, the manifold tubes 440/442 are identical pieces, with each one turned to face the other so the compound reference number usage 440/442 will be familiar to the reader. The manifold tubes are disposed at their bosses 440a/442a toward one another, and each one sealingly receives a respective end portion of the mat 444, while providing flow communication between the plural tubes 446 and the respective manifold tube 440/442.

Recalling FIGS. 6, 6A, and 7, it is seen that in the case of the embodiment of FIG. 12, that manifold tubes 440/442 define an elongate downwardly opening socket indicated with the reference numeral 460. This socket 460 receives a respective “mold-over” plug member, indicated with the numeral 462. This plug member 462 depends below the manifold tubes 440/442, and sealingly joins with the plurality of tubes 446 of the mat 444. As is seen in FIG. 12, the plug member 462 defines an opening passage 464, or a respective plurality of opening passages 464. A preferred construction is seen in FIG. 12, in which the plug member defines a single flow passage 464, which is essentially an elongate basin with outwardly tapering side walls. Alternatively, if greater strength is required for the plug member 462 (i.e., in order to better hold its shape during the “over-molding process), it may be made with a respective plurality of flow passages 464, each communicating individually between a respective one of the plural solar collector tubes and the passage 456 of the manifold tubes 440/442. In this way, the material of plug member 462 between the flow passages 464 may better support this plug member against the pressures of the over-molding injection molding process. The plug member 462 is preferably manufactured by injection molding this plug member directly onto an end portion of a section of mat material 444, with the injection molding process essentially making the plug member 462 integral with the mat. Again, and similar to the embodiment seen in FIGS. 6-7. Again, the most preferred manufacturing method for producing the manifold tubes 440/442 is to over mold (i.e., injection mold) the manifolds 440/442 directly upon the plug member 462. By the use of this “over-molding manufacturing method, the plug member 460 and manifolds 440/442 become essentially integral with one another.

Viewing FIG. 12, it is important to note that the plug member 460 both defines a portion of the inner surface of the passage 456 of the manifold tube 440 seen in FIG. 12, and also defines at least one (or plural respective) circumferentially elongated (or chamfered) flow passage 464 opening to the interior of the manifold tubes 240/242. Preferably, all of the solar collector tubes 446 open to a single elongated flow passages 464, and thus communicates with the passage 456 of the manifold tube, as is seen in FIG. 12. Importantly, the “chamfered” flow passage 464 has an included angle of about 50°. As a result, the solar panel 430 will drain completely provided that its angle of incline is from just off horizontal, up to an angle of 25° from horizontal. Because in the US, the usual roof inclination is not more than 25°, the solar panel 430 will completely drain when mounted on the usual roof. Of course, FIG. 12 is illustrative only, and the invention may be made with the flow passages 464 having an included angle of more than the illustrated 50° so that complete draining of a solar panel is accomplished even if the roof or support rack has an inclination of more than 25°.

It should be understood, of course, that the foregoing relates merely to exemplary preferred embodiments of the invention, and that modifications or improvements may be made without departing from the spirit and scope of the invention as set forth in the following claims.

I claim:

1. A solar panel formed of plastic material and configured for heating water at low pressure when exposed to solar radiation, said solar panel comprising:
a planar flexible mat of plural elongate plastic solar collector tubes each having a coextensive first open end and an opposite coextensive second open end, and said plural elongate plastic tubes being interconnected to form said mat by comparatively thin web members interconnecting each tube to a next-adjacent tube;
a pair of manifold tubes each interconnecting in flow communication with said plural elongate plastic tubes of said mat at respective opposite ends of the latter, each of said pair of manifold tubes outwardly defining a boss providing for interconnection of said mat of plural elongate plastic tubes with the respective one of said pair of manifold tubes, and said mat of plural elongate plastic tubes being disposed below a centerline of at least one of said pair of manifold tubes.

2. A solar panel according to claim 1 wherein said mat of plural elongate plastic solar collector tubes is disposed essentially tangential to said at least one manifold tube.

3. A solar panel according to claim 1 wherein said mat of plural elongate plastic solar collector tubes is disposed essentially tangential to each one of said pair of manifold tubes; whereby, said mat of plural elongate plastic solar collector tubes and said pair of manifold tubes are cooperatively coextensive along a bottom side of said solar panel.

4. A solar panel according to claim 3 wherein said mat of plural elongate plastic tubes has a center line generally in a plane, and said centerline of said mat of plural elongate plastic tubes is disposed essentially tangentially to a side wall of a water flow passage of each of said pair of manifold tubes.

5. A solar panel according to claim 3, wherein at least one of said pair of manifold tubes is open at each opposite end thereof, and said at least one manifold tube defines a hose barb circumscribing each of said opposite end openings.

6. A solar panel according to claim 3 wherein each of said pair of manifold tubes includes an elongate linear plurality of outwardly projecting nipple connections disposed toward said mat of plural elongate plastic tubes, and each plastic tube of said mat of plural elongate plastic tubes is individually received onto a respective one of said nipple connections in order to place said plastic tube into flow communication between said pair of manifold tubes.

7. A solar panel according to claim 3 wherein each of said pair of manifold tubes defines on said boss thereof a bluff surface disposed toward the other of said pair of manifold tubes, and a plurality of flow openings communicating between said bluff surface and a flow passage of the respective manifold tube, so that said mat of plural elongate plastic tubes is sealingly joined to said pair of manifold tubes at said bluff surface with an individual one of said flow passages in flow communication with a respective one of said plurality of elongate plastic tubes.

8. A solar panel according to claim 7 wherein said mat of plural elongate plastic tubes is adhesively sealingly joined to said pair of manifold tubes at said bluff surfaces.

9. A solar panel according to claim 7 wherein said mat of plural elongate plastic tubes is sealingly joined by ultrasonic welding to said pair of manifold tubes at said bluff surfaces.

10. A solar panel according to claim 1 wherein each of said pair of manifold tubes defines on said boss thereof a socket for receiving a plug member sealingly attached to a respective end portion of said mat of plural elongate plastic tubes.

11. A solar panel according to claim 10 wherein said plug member is over-molded into integral union with said mat of plural elongate plastic tubes, and defines a respective one of plural flow passages opening on an angulated face of said plug member.

12. A solar panel according to claim 11 wherein each respective one of said pair of manifold tubes is over-molded in integral union with a respective one of a pair of plug members joined with said mat of plural elongate plastic tubes, so that said plural flow passages of said plug member open essentially tangentially to a flow passage of said manifold tube.

13. A solar panel according to claim 10 wherein said plug member is over-molded into integral union with said mat of plural elongate plastic tubes, and said plug member depends from said manifold tube to inwardly define a flow passage opening upwardly into a respective flow passage of said manifold tube, and said flow passage of said plug member defining upwardly angulated divergent side walls so that said flow passage defines an included angle opening upwardly as a basin to said manifold tube flow passage.

14. A solar panel according to claim 13 wherein said plug member defines plural flow passages each opening upwardly to a flow passage of said manifold tube via upwardly and outwardly angulated divergent side walls.

15. A solar panel according to claim 1 wherein each respective one of said pair of manifold tubes is over-molded in integral union with said mat of plural elongate plastic tubes, so that said plural solar collector tubes of said mat open essentially tangentially to a flow passage of said manifold tube.

16. A solar panel according to claim 15 wherein each respective one of said plural solar collector tubes of said mat at an end portion thereof coextensive with a respective one of said manifold tubes receives a metallic reinforcing eyelet, whereby said mat of solar collector tubes is supported by said eyelets during over-molding of said manifold tubes.

17. A method of providing a solar panel formed of plastic material and configured for heating water at low pressure when exposed to solar radiation, said method comprising steps of:
providing an essentially planar and flexible mat consisting of plural elongate plastic solar collector tubes each having a coextensive first open end and an opposite coextensive second open end, and said plural elongate plastic tubes being interconnected by comparatively thin web members interconnecting each tube to a next-adjacent tube to form said mat;
providing a pair of manifold tubes each interconnecting in flow communication with said plural elongate plastic tubes of said mat at respective opposite ends of the latter, providing at least one of said pair of manifold tubes with an outwardly extending boss providing for interconnection of said mat of plural elongate plastic tubes with the respective one of said pair of manifold tubes, and
disposing said mat of plural elongate plastic tubes below a centerline of said at least one of said pair of manifold tubes.

18. A method according to claim 17 further including the step of disposing said mat of plural elongate plastic solar collector tubes essentially tangential to said at least one manifold tube.

19. A method according to claim 17 including the step of disposing said mat of plural elongate plastic solar collector tubes essentially tangential to each one of said pair of manifold tubes; whereby, said mat of plural elongate plastic solar collector tubes and said pair of manifold tubes are cooperatively coextensive along a bottom side of said solar panel.

20. A method according to claim 17 including steps of; providing for said mat of plural elongate plastic tubes to have a center line of each tube generally all in a plane, and disposing said centerline of said mat of plural elongate plastic tubes essentially tangential to a side wall of a water flow passage of each of said pair of manifold tubes.

21. A method according to claim 17, including configuring at least one of said pair of manifold tubes to be open at each opposite end thereof, and providing a hose barb circumscribing each of said opposite end openings of said at least one manifold tube.

22. A method according to claim 17, including providing each of said pair of manifold tubes with an elongate linear plurality of outwardly projecting nipple connections disposed on said boss of said manifold tube and extending toward said mat of plural elongate plastic tubes, and individually receiving each plastic tube of said mat of plural elongate plastic tubes onto a respective one of said nipple connections in order to place said plastic tube into flow communication between said pair of manifold tubes.

23. A method according to claim 17, including defining on said boss of each of said pair of manifold tubes a bluff surface disposed toward the other of said pair of manifold tubes, and providing on said bluff surface a plurality of flow openings communicating between said bluff surface and a flow passage of the respective manifold tube; and sealingly joining said mat of plural elongate plastic tubes to said pair of manifold tubes at said bluff surfaces with an individual one of said flow passages in flow communication with a respective one of said plurality of elongate plastic tubes.

24. A method according to claim 23, including adhesively sealingly joined a respective one of said plurality of elongate plastic tubes to said pair of manifold tubes at said flow openings on said bluff surfaces.

25. A method according to claim 23, including sealingly joining said mat of plural elongate plastic tubes by ultrasonic welding to said pair of manifold tubes at said bluff surfaces and individually in flow communication with said flow openings.

26. A method according to claim 17, including integrally over-molding on said mat of plural elongate plastic tube a plug member defining a respective plurality of flow openings each opening on an angulated face of said plug member.

27. A method according to claim 20, including the step of over-molding a manifold tube in integral union with a plug member joined with said mat of plural elongate plastic tubes, so that said plural flow openings defined by said plug member open essentially tangentially to a flow passage of said manifold tube.

28. A method according to claim 17 including over-molding said plug member into integral union with said mat of plural elongate plastic tubes, providing for said plug member to depend from said manifold tube and to inwardly define a flow passage opening upwardly into a respective flow passage of said manifold tube, and configuring said flow passage of said plug member to define upwardly angulated divergent side walls so that said flow passage defines an included angle opening upwardly as a basin to said manifold tube flow passage.

29. A method according to claim 28 including utilizing said plug member to defines plural flow passages each opening upwardly from a respective solar collector tube of said mat to a flow passage of said manifold tube via upwardly and outwardly angulated circumferentially divergent side walls.

30. A method according to claim 17 including the step of over-molding a manifold tube in integral union directly with said mat of plural elongate plastic tubes, so that said plural solar collector tubes of said mat open essentially tangentially to a flow passage of said manifold tube.

31. A method according to claim 30 including the steps of providing within each respective one of said plural solar collector tubes of said mat at an end portion thereof and coextensive with a respective one of said manifold tubes a metallic reinforcing eyelet, and utilizing said eyelets to support said mat of solar collector during over-molding of said manifold tube.

32. A bridge member for effecting securing to a support surface, such as a roof or support rack, of an extruded plastic low-pressure solar panel consisting of a mat of plural spaced apart solar collector tubes interconnected by comparatively thin web sections, said bridge member comprising;
an elongate body defining a lower face confronting said solar panel, said lower face including a plurality of cross channels corresponding in size, location, and mutual spacing to said solar collector tubes, and an intervening plurality of lands between said channels and corresponding each to interconnecting web sections of said solar panel, whereby said bridge member intermeshes at said lower face with said solar panel;
said elongate body also defining an upper face of shallow inverted V-shape, and defining an apex substantially at a mid-width location of said solar panel, and an elongate groove extending the length of said elongate body and across said apex, whereby an elongate tension member trained in said elongate groove and at opposite ends being secured to said support surface applies at said first face a distributed securing force to said solar panel.
